(19) United States
(12) Patent Application Publication
(10) Pub. No.: US 2025/0347791 A1
(43) Pub. Date: Nov. 13, 2025

(54) COMPUTER-IMPLEMENTED METHOD FOR TRAINING AN ARTIFICIAL INTELLIGENCE (AI) MODULE FOR DETERMINING AN OBJECT IN AN ENVIRONMENT OF A VEHICLE

(71) Applicant: Robert Bosch GmbH, Stuttgart (DE)

(72) Inventors: Andre Gerlach, Leonberg-Hoefingen (DE); Jona Eisele, Kornwestheim (DE)

(21) Appl. No.: 19/189,386

(22) Filed: Apr. 25, 2025

(30) Foreign Application Priority Data
May 7, 2024 (DE) 10 2024 204 244.7

(51) Int. Cl. G01S 7/539

(52) U.S. Cl. CPC G01S 7/539

(57) ABSTRACT

A computer-implemented method for training an artificial intelligence module for determining an object in an environment of a vehicle. The method includes: providing a measured value dataset on a data carrier, wherein the measured value dataset comprises at least one data entry about a reflection of an ultrasonic signal in an airborne sound range and at least one data entry about a class of an object; generating a modified training dataset based on the measured value dataset, wherein generating the modified training dataset comprises the following steps: creating an input dataset based on the data entry about the reflection of the ultrasonic signal in the airborne sound range, creating an output dataset based on the data entry about the class of the object, wherein the method further comprises training an AI module based on the modified training dataset.

### CROSS REFERENCE

The present application claims the benefit under 35 U.S.C. § 119 of German Patent Application No. DE 10 2024 204 244.7 filed on May 7, 2024, which is expressly incorporated herein by reference in its entirety.

### FIELD

The present invention relates to a computer-implemented method for training an artificial intelligence (AI) module for determining an object in an environment of a vehicle, to a sensor system and to a vehicle.

### BACKGROUND INFORMATION

There is currently a large number of different solutions for evaluating ultrasonic signals in the vehicle sector. Due to the increasing demands on detection accuracy as well as the increased quality expectations, the need for innovative and robust evaluation methods of ultrasonic signals is continuously increasing.

Continuous weight reduction in the vehicle sector for reducing consumption and increasing competition are putting pressure on costs, and therefore cheaper and more efficient components for vehicles are in greater demand.

### SUMMARY

The computer-implemented method according to the present invention for training an AI module for determining an object in an environment of a vehicle may have the advantage over the conventional method that the detection accuracy of an object classification by means of an ultrasonic sensor, in particular an ultrasonic array sensor, can be significantly improved. This can, in particular, significantly increase the performance of environment sensing in the vicinity of the vehicle, in particular with regard to object classification of obstacles around a vehicle. More preferably, a distinction between potentially a plurality of objects at the same distance, in particular from the vehicle, can be made possible.

This is achieved according to the present invention in that the computer-implemented method for training an AI module for determining an object in an environment of a vehicle according to an example embodiment of the present invention comprises the following steps:
providing a measured value dataset on a data carrier, wherein the measured value dataset comprises at least one data entry about a reflection of an ultrasonic signal in an airborne sound range and at least one data entry about a class of an object,
generating a modified training dataset based on the measured value dataset, wherein generating the modified training dataset comprises the following steps:
creating an import dataset based on the data entry about the reflection of the ultrasonic signal in the airborne sound range,
creating an output dataset based on the data entry about the class of the object,
wherein the method further comprises the following step:
training an AI module on the basis of the modified training dataset.

In other words, an object can be identified on the basis of a reflection of an ultrasonic signal by means of a trained AI module. In particular, the ultrasonic signal can be an ultrasonic array signal that was ascertained by means of beamforming. More preferably, according an example embodiment of the present invention, an ultrasonic sensor array can be used to ascertain input features that can be used for object classification by means of the AI module. The ultrasonic sensor array can, in particular, comprise a plurality of ultrasonic transducer elements. For example, a first input feature can be a time-resolved signal. In particular, a time-resolved signal of the backscattered sound pressure at the output of each transducer element can be used as a feature. More preferably, a time-resolved signal of the backscattered sound pressure from a delay and summation calculation, in particular beamforming, can be used. In addition to a time signal, the complex baseband or the amplitude height curve can also be a representation of the time signal. A further feature can be, in particular, the calculation of time-frequency representations, such as short-time Fourier transform or wavelet transform. A further feature can comprise, in particular, the calculation of acoustic source maps using beamforming methods such as Delay & Sum calculations, the Bartlett method, and/or the MUSIC method. More preferably, an input feature can further involve the extraction of bounding boxes or segmentation of object contours from the source maps of the previous feature. More preferably, a further input feature can comprise a calculation of individual object points with direction and distance features from the source maps.

Preferred developments of the present invention are disclosed herein.

More preferably, according to an example embodiment of the present invention, the method comprises the following for some steps:
forming a time profile based on the data entry about the reflection,
expanding the input dataset by means of the time profile.

An advantage of this embodiment is that the received ultrasound signals can be set in a temporal profile in order to increase the informative value.

More preferably, according to an example embodiment of the present invention, the method comprises the following for some steps:
forming a time-frequency ratio based on the formed time profile and the data entry about the reflection,
expanding the input dataset by means of the time-frequency ratio.

An advantage of this type of formation is that the formed ratio allows the relationship of the received ultrasound data signals to be taken into account when training the AI module, so that the detection accuracy of objects can be further increased.

More preferably, according to an example embodiment of the present invention, the measured value dataset comprises a data entry about a plurality of reflections of an ultrasonic signal, which was emitted by means of an ultrasonic array, in the airborne sound range, wherein the method comprises the following steps:
forming a source map based on the data entry about the plurality of reflections,
expanding the input dataset by means of the source map.

An advantage of this example embodiment is that by forming the source map, relationships between the ultrasound signals, in particular multidimensional ones, can always be taken into account.

More preferably, according to an example embodiment of the present invention, the method comprises the following steps:
ascertaining at least one bounding body and/or an object contour on the basis of the formed source map,
expanding the input dataset by means of the bounding body and/or the object contour.

An advantage of this example embodiment is that, on the basis of the ascertained bounding body and/or the object contour, in particular different object classes can be excluded. For example, if a rectangular contour is recognized, an object such as a ball, which has a round contour, can be excluded from further object classification.

More preferably, according to an example embodiment of the present invention, the source map comprises at least one vector that describes a reflection travel and/or a reflection orientation, wherein the method comprises the following steps:
ascertaining an object reference, in particular an object center point, on the basis of the source map having the at least one vector,
expanding the input dataset by means of the ascertained object reference points.

An advantage of this embodiment is that the data can be processed much more easily, since the position in three-dimensional space can be easily determined on the basis of the vector with the object center point.

A further aspect of the present invention relates to a sensor system. According to an example embodiment of the present invention, the sensor system comprises an ultrasonic sensor unit, wherein the ultrasonic sensor unit is configured to emit at least one ultrasonic signal in an airborne sound range, wherein the ultrasonic sensor unit is configured to receive the emitted ultrasonic signal in the airborne sound range, wherein the sensor system is connectable to an AI module that has been trained using the method as described above and below, wherein the sensor system is configured to determine a class of an object in an environment of the sensor system by means of the AI module and the received ultrasonic signal.

An advantage of this embodiment is that the detection accuracy of a sensor system can be significantly improved by means of the AI module and its object classification. In particular, object classification can be improved for objects that are in particular at substantially the same distance from the sensor system.

More preferably, according to an example embodiment of the present invention, the ultrasonic sensor unit comprises an ultrasonic array having a plurality of ultrasonic elements, wherein the ultrasonic sensor unit is configured to emit an ultrasonic wave set that comprises the ultrasonic signal by means of the ultrasonic array, wherein the ultrasonic sensor unit is configured to adjust an orientation of the ultrasonic wave set.

An advantage of this embodiment is that the ultrasonic wave set can provide spatial resolution, such as by means of beamforming. Thus, in particular, a source map can be calculated. In particular, an acoustic source map can be created by means of adjusting the ultrasonic wave set in order to be able to represent two- or three-dimensional sound pressures or other quantities. Possible calculation methods can be used in particular as Delay & Sum, Capon, Clean SC, MUSIC or the like. More preferably, according to an example embodiment of the present invention, the ultrasonic sensor unit is configured to create a source map by adjusting the orientation of the ultrasonic wave set.

An advantage of this embodiment is that the processing of the ultrasound signals can be significantly simplified with the aid of the source map.

More preferably, according to an example embodiment of the present invention, the sensor system is configured to ascertain a contour of the object on the basis of the received ultrasonic signal.

An advantage of this embodiment is that by ascertaining the contours or bounding bodies or the like, a number of detected objects can be ascertained. In particular, an estimate of the number of ascertained objects and their spatial locations can be ascertained on the basis of their contours. In particular, the bounding bodies and/or contours are a simple geometric representation that can enclose a more complex two- or multi-dimensional object in the source map. A contour can in particular be an outline, such as a line, which describes a body or its edges as an outer line and can be determined by means of image sequencing. In particular, the bounding bodies and/or the contours can be determined on the basis of the source map and thus other visual presentations of the vehicle environment can also be transmitted. More preferably, simple methods can be used for calculating bounding boxes or contours. In particular, point groups from bounding bodies or contours can be included. More preferably, the maximum can be selected as the first point and then further point groups with decreasing amplitude. More preferably, methods can be used that use separate neural networks for calculating bounding bodies or contours, such as Mask-R-CNN or SegNet.

More preferably, according to an example embodiment of the present invention, the sensor system is configured to ascertain a center point of the object on the basis of the received ultrasonic signal.

An advantage of this embodiment is that the computing effort can be significantly reduced, since no bounding bodies or contours are to be ascertained, for example, and resources can thus be saved. In particular, a number of objects can be ascertained by determining the object center points.

More preferably, according to an example embodiment of the present invention, the ultrasonic sensor unit is configured to emit and receive a second ultrasonic wave set, wherein the ultrasonic sensor unit is configured to adjust an orientation of the second ultrasonic wave set on the basis of the ascertained contour and/or the ascertained center point of the object.

An advantage of this embodiment is that the object classification is limited only to regions in the environment of the sensor system in which objects were suspected or detected, in order to thus be able to save further resources.

More preferably, according to an example embodiment of the present invention, the sensor system is configured to adjust the source map on the basis of the received second ultrasonic wave set.

An advantage of this embodiment is that the detection of the objects can be checked in order to preferably exclude false positives or other detection errors. A second beamforming can be performed, in particular on the basis of the source map. The number of cut-out partial source maps preferably corresponds to the number of objects, wherein for each object the source map can be limited to the corresponding regions, taking into account the bounding bodies or contours. If center points of the objects are available, the source map can be limited to a specified region. Preferably, using the division of the source map, processing by means of a classification network can be significantly simplified.

More preferably, according to an example embodiment of the present invention, the sensor system is configured to determine the class of the object in the environment of the sensor system by means of the AI module, the adjusted source map, the ascertained contour of the object and/or the ascertained center point of the object.

An advantage of this embodiment is that the detection accuracy can be significantly improved by means of the AI module, since the inputs, in particular with the adjusted source map or partial source map, are significantly simplified for the classification. Preferably, a neural network or the like can be used for classification. Preferably, a convolutional neural network can be used for this purpose, as well as other network architectures such as MLPs, RNNs, transformers, autoencoders or combinations of these.

A further aspect of the present invention relates to a vehicle that comprises a sensor system of the present invention as described above and below and/or comprises an AI module that has been trained by means of the method of the present invention as described above and below.

### BRIEF DESCRIPTION OF THE DRAWINGS

In the following, exemplary embodiments of the present invention are described in detail with reference to the figures.

FIGS. 1 and 2 are each a diagram illustrating the functioning of the sensor system according to one example embodiment of the present invention.

FIG. 3 shows a sensor system according to one example embodiment of the present invention.

FIG. 4 shows a vehicle according to one example embodiment of the present invention.

FIGS. 5 and 6 are each a flow chart illustrating the method according to one example embodiment of the present invention.

### DETAILED DESCRIPTION OF EXAMPLE EMBODIMENTS

Preferably, all the same elements, units and/or steps in all figures are provided with the same reference signs.

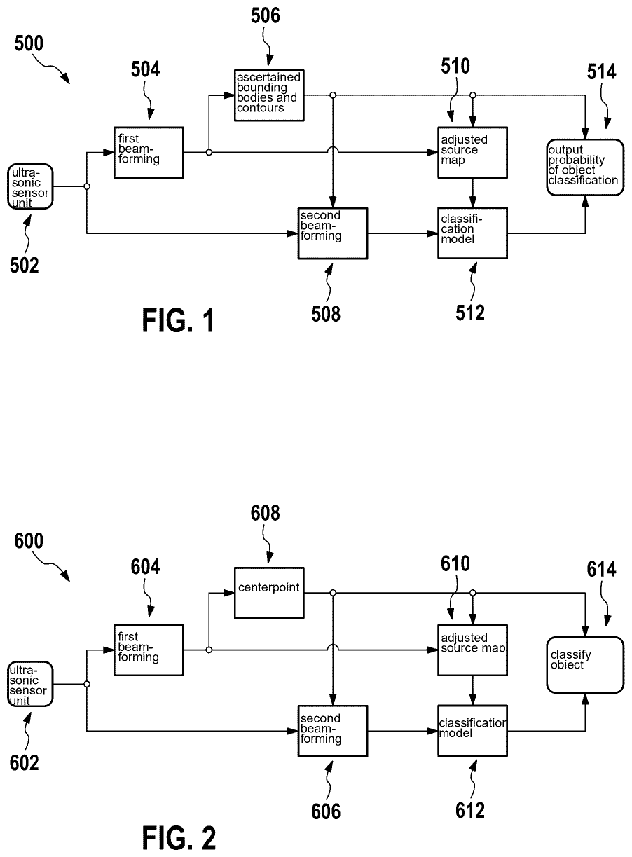

FIG. 1 is a diagram 500 for illustrating the functioning of the sensor system 300. The diagram 500 comprises an ultrasonic sensor unit 502. The ultrasonic sensor unit 502 can in particular send and receive ultrasonic signals, which are used in particular for beamforming 504. On the basis of beamforming 504, bounding bodies and contours of the objects can be ascertained. On the basis of the ascertained bounding bodies and contours 506, a second beamforming 508 can be performed, in particular by means of the ultrasonic sensor unit 502. More preferably, a source map that was ascertained by means of the first beamforming 504 can be adjusted in step 510. On the basis of the second beamforming 508 and in the adjusted source map 510, a probability of an object classification can be output in step 514 by means of a classification model 512.

FIG. 2 is a diagram 600 for illustrating the functioning of the sensor system 300. In particular, the diagram 600 comprises an ultrasonic sensor unit 602. In particular, a center point 608 can be ascertained by means of a first beamforming 604. On the basis of the ascertained center points 608, a second beamforming 606 can be performed by means of the ultrasonic sensor unit 602. More preferably, a source map 610 can be adjusted on the basis of the first beamforming 604 and the ascertained center points 608. On the basis of the adjusted source map 610 and in the second beamforming 606, an object can be classified 614 by means of a classification model 612.

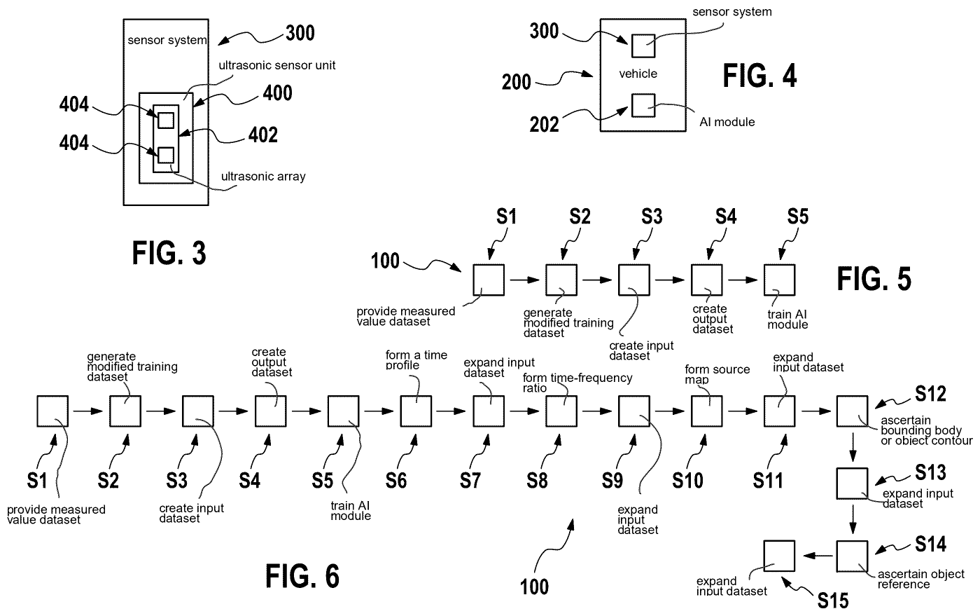

FIG. 3 shows a sensor system 300 according to one embodiment. The sensor system 300 comprises an ultrasonic sensor unit 400, wherein the ultrasonic sensor unit 400 is configured to emit at least one ultrasonic signal in an airborne sound range, wherein the ultrasonic sensor unit 400 is configured to receive the emitted ultrasonic signal in the airborne sound range, wherein the sensor system 300 is connectable to an AI module 202 that has been trained by means of the method 100 as described above and below, wherein the sensor system 300 is configured to determine a class of an object in an environment of the sensor system 300 by means of the AI module 202 and the received ultrasonic signal. Preferably, the sensor system 300 can comprise an AI module 200 and also form a data connection with an AI module 202 in order to be able to determine the class of the object.

FIG. 4 shows a vehicle 200 according to one embodiment. The vehicle 200 preferably comprises a sensor system 300 as described above and below. More preferably, the vehicle 200 can comprise an AI module 202 that has been trained using the method 100 as described above and below.

FIG. 5 is a flow chart illustrating steps of the method 100 according to one embodiment. The method 100 for training an AI module 202 for determining an object in an environment of a vehicle 200 comprises the following steps:
providing S1 a measured value dataset on a data carrier, wherein the measured value dataset comprises at least one data entry about a reflection of an ultrasonic signal in an airborne sound range and at least one data portion about a class of an object,
generating S2 a modified training dataset based on the measured value dataset, wherein generating the modified training dataset comprises the following steps:
creating S3 an input dataset based on the data entry about the reflection of the ultrasonic signal in the airborne sound range,
creating S4 an output dataset based on the data entry about the class of the object,
wherein the method 100 further comprises the following step:
training S5 an AI module 202 on the basis of the modified training dataset.

FIG. 6 is a flow chart illustrating steps of the method 100 according to one embodiment. The method 100 preferably comprises the same steps S1 to S5 as those already explained with regard to FIG. 5. More preferably, the method 100 further comprises the steps of forming S6 a time profile and expanding S7 the input dataset. More preferably, the method 100 comprises the steps of forming S8 a time-frequency ratio and expanding S9 an input dataset. More preferably, the method 100 comprises the steps of forming S10 a source map and expanding S11 the input dataset by means of the source map. Preferably, the method 100 comprises the steps of ascertaining S12 a bounding body or an object contour and preferably expanding S13 the input dataset by means of the bounding body and/or the object contour. More preferably, the method 100 further comprises the steps of ascertaining S14 an object reference and expanding S15 the input dataset.

What is claimed is:

1. A computer-implemented method for training an artificial intelligence (AI) module for determining an object in an environment of a vehicle, comprising the following steps:
providing a measured value dataset on a data carrier, wherein the measured value dataset includes at least one data entry about a reflection of an ultrasonic signal in an airborne sound range and at least one data entry about a class of an object;
generating a modified training dataset based on the measured value dataset, wherein the generating of the modified training dataset includes:
creating an input dataset based on the data entry about the reflection of the ultrasonic signal in the airborne sound range, and
creating an output dataset based on the data entry about the class of the object; and
training the AI module based on the modified training dataset.

2. The method according to claim 1, further comprising the following steps:
forming a time profile based on the data entry about the reflection;
expanding the input dataset by means of the time profile.

3. The method according to claim 2, further comprising the following steps:
forming a time-frequency ratio based on the formed time profile and the data entry about the reflection; and
expanding the input dataset using the time-frequency ratio.

4. The method according to claim 1, wherein the measured value dataset includes a data entry about a plurality of reflections of an ultrasonic signal, which were emitted using an ultrasonic array, in the airborne sound range, and wherein the method further comprises the following steps:
forming a source map based on the data entry about the plurality of reflections,
expanding the input dataset using the source map.

5. The method according to claim 4, further comprising the following steps:
ascertaining at least one bounding body and/or an object contour based on the formed source map; and
expanding the input dataset using the bounding body and/or the object contour.

6. The method according to claim 4, wherein the source map includes at least one vector that describes a reflection path and/or a reflection orientation, and wherein the method further comprises the following steps:
ascertaining an object reference including an object center point, based on the source map having the at least one vector,
expanding the input dataset using the ascertained object reference.

7. A sensor system, comprising:
an ultrasonic sensor unit, wherein the ultrasonic sensor unit is configured to emit at least one ultrasonic signal in an airborne sound range, wherein the ultrasonic sensor unit is configured to receive the emitted ultrasonic signal in the airborne sound range, wherein the sensor system is connectable to an artificial intelligence (AI) module that has been trained by:
providing a measured value dataset on a data carrier, wherein the measured value dataset includes at least one data entry about a reflection of an ultrasonic signal in the airborne sound range and at least one data entry about a class of an object,
generating a modified training dataset based on the measured value dataset, wherein the generating of the modified training dataset includes:
creating an input dataset based on the data entry about the reflection of the ultrasonic signal in the airborne sound range, and
creating an output dataset based on the data entry about the class of the object; and
training the AI module based on the modified training dataset,
wherein the sensor system is configured to determine a class of an object in an environment of the sensor system using the trained AI module and the received ultrasonic signal.

8. The sensor system according to claim 7, wherein the ultrasonic sensor unit includes an ultrasonic array having a plurality of ultrasonic elements, wherein the ultrasonic sensor unit is configured to emit an ultrasonic wave set that includes the ultrasonic signal using the ultrasonic array, wherein the ultrasonic sensor unit is configured to adjust an orientation of the ultrasonic wave set.

9. The sensor system according to claim 8, wherein the ultrasonic sensor unit is configured to create a source map by adjusting the orientation of the ultrasonic wave set.

10. The sensor system according to claim 7, wherein the sensor system is configured to ascertain a contour of the object based on the received ultrasonic signal.

11. The sensor system according to claim 7, wherein the sensor system is configured to ascertain a center point of the object based on the received ultrasonic signal.

12. The sensor system according to claim 9, wherein the ultrasonic sensor unit is configured to emit and receive a second ultrasonic wave set, wherein the ultrasonic sensor unit is configured to adjust an orientation of the second ultrasonic wave set based on the ascertained contour and/or the ascertained center point of the object.

13. The sensor system according to claim 12, wherein the sensor system is configured to adjust the source map on the basis of the received second ultrasonic wave set.

14. The sensor system according to claim 13, wherein the sensor system is configured to determine the class of the object in the environment of the sensor system using the trained AI module, the adjusted source map, the ascertained contour of the object and/or the ascertained center point of the object.

15. A vehicle, comprising:
a sensor system, including:
an ultrasonic sensor unit, wherein the ultrasonic sensor unit is configured to emit at least one ultrasonic signal in an airborne sound range, wherein the ultrasonic sensor unit is configured to receive the emitted ultrasonic signal in the airborne sound range, wherein the sensor system is connectable to an artificial intelligence (AI) module that has been trained by:
providing a measured value dataset on a data carrier, wherein the measured value dataset includes at least one data entry about a reflection of an ultrasonic signal in the airborne sound range and at least one data entry about a class of an object,
generating a modified training dataset based on the measured value dataset, wherein the generating of the modified training dataset includes:
creating an input dataset based on the data entry about the reflection of the ultrasonic signal in the airborne sound range, and
creating an output dataset based on the data entry about the class of the object; and
training the AI module based on the modified training dataset,
wherein the sensor system is configured to determine a class of an object in an environment of the sensor system using the trained AI module and the received ultrasonic signal.
